(19) United States
(12) Patent Application Publication
(10) Pub. No.: US 2012/0063515 A1
(43) Pub. Date: Mar. 15, 2012

(54) Efficient Coding of Video Parameters for Weighted Motion Compensated Prediction in Video Coding

(75) Inventors: Rahul P. Panchal, San Diego, CA (US); Marta Karczewicz, San Diego, CA (US); Peisong Chen, San Diego, CA (US)

(73) Assignee: QUALCOMM Incorporated, San Diego, CA (US)

(21) Appl. No.: 13/117,903

(22) Filed: May 27, 2011

Related U.S. Application Data
(60) Provisional application No. 61/381,167, filed on Sep. 9, 2010.

(51) Int. Cl. H04N 7/32

(52) U.S. Cl. 375/240.16; 375/E07.123

(57) ABSTRACT

This disclosure relates to techniques for efficient coding of video parameters for weighted motion compensated prediction in video encoding and decoding. A video coding device may code a video block using weighted motion compensated prediction with respect to prediction data generated based on at least one motion vector and video parameter values. The video parameter values may include scale and/or offset parameter values. The techniques reduce signaling overhead by only signaling video parameter values when the motion vector points to a predefined sub-pixel position of a reference block. The techniques include storing a list of predefined sub-pixels associated with the video parameters. When the motion vector points to a sub-pixel position included in the list of predefined sub-pixels, the video coding device may code the video parameter values. The list of predefined sub-pixels may be signaled to a video decoder at a video coding unit or higher level.

This application claims the benefit of U.S. Provisional Application No. 61/381,167, filed Sep. 9, 2010, which is hereby incorporated by reference in its entirety.

### TECHNICAL FIELD

This disclosure relates to video coding and, more particularly, motion compensated prediction for video coding.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), or the emerging High Efficiency Video Coding (HEVC) standard, and extensions of such standards.

Video compression techniques perform spatial prediction and/or temporal prediction to reduce or remove redundancy inherent in video sequences. For block-based video coding, a video frame or slice may be partitioned into video blocks or coding units (CUs). Video blocks in an intra-coded (I) frame are coded using spatial prediction with respect to neighboring blocks. Video blocks in an inter-coded (P or B or GPB) frame may use temporal prediction with respect to blocks in other reference frames. In the case of inter-coding, a video coding device first performs motion estimation to generate motion vectors that indicate displacement of video blocks relative to corresponding reference blocks. In some coding processes, the reference blocks may be interpolated to produce values at sub-pixel positions, such as quarter-pixel or half-pixel positions. In this case, motion vectors may point to sub-pixel positions of the reference blocks to provide higher precision motion compensated prediction.

The video coding device then performs motion compensation to generate predictive blocks based on the reference blocks and the motion vectors. In the case of weighted motion compensated prediction, video parameter values may be applied to the predictive blocks used to code the video blocks to provide more accurate compensation than the original predictive blocks. Video parameter values may include scale parameter values and/or offset parameter values used to compensate for luminance and/or chrominance changes during a video scene. For example, scale parameter values and offset parameter values may be used during a transition period of a luminance effect, such as a cross-fade, fade-in, fade-out, flash, or the like, that often occurs over several frames. After motion compensation, residual video blocks are formed by subtracting the prediction data from the original video blocks to be coded.

### SUMMARY

In general, this disclosure describes techniques for efficient coding of video parameters for weighted motion compensated prediction in video encoding and decoding. A video coding device may code a video block using weighted motion compensated prediction with respect to prediction data generated based on at least one motion vector and video parameter values associated with the motion vector. The video parameter values may include, for example, a scale parameter value and/or an offset parameter value used to adjust prediction data for the video block to compensate for luminance and/or chrominance changes. Conventionally, both the motion vector and the video parameter values associated with the motion vector are signaled to a video decoder for every block. Signaling video parameter values with every motion vector, however, leads to substantial overhead and may not provide any coding efficiency advantage.

The techniques of this disclosure reduce signaling overhead by only signaling video parameter values for weighted motion compensated prediction when the motion vector points to a predefined sub-pixel position of the reference block. More specifically, the techniques include storing a list of predefined sub-pixels associated with one or more video parameters. In this way, when the motion vector points to a sub-pixel position of the reference block that is included in the list of predefined sub-pixels, a video encoder may encode video parameter values associated with the motion vector. The video encoder may then encode the video block using weighted motion compensated prediction with respect to prediction data generated based on the motion vector and the video parameter values.

Moreover, the list of predefined sub-pixels may be signaled to a video decoder at one of a video coding unit level, a video slice level, a video frame level, or a video sequence level. In this way, the video decoder expects to receive the video parameter values when the decoded motion vector points to one of the predefined sub-pixels included in the list. The video decoder may then properly parse the syntax elements indicating the video parameter values, and accurately decode the video block with respect to prediction data generated based on the motion vector and the video parameter values associated with the motion vector.

In one example, the disclosure describes a method of coding video data. The method comprises storing a list of predefined sub-pixels associated with one or more video parameters, coding syntax elements indicating at least one motion vector for a video block with respect to a reference block having sub-pixel resolution, and, when the motion vector points to a sub-pixel position of the reference block that is included in the list of predefined sub-pixels, coding syntax elements indicating video parameter values associated with the motion vector, and coding the video block with respect to prediction data generated based on the motion vector and the video parameter values.

In another example, the disclosure describes a video coding device comprising a memory that stores a list of predefined sub-pixels associated with one or more video parameters, and a processor that codes syntax elements indicating at least one motion vector for a video block with respect to a reference block having sub-pixel resolution, and, when the motion vector points to a sub-pixel position of the reference block that is included in the list of predefined sub-pixels, codes syntax elements indicating video parameter values associated with the motion vector and codes the video block with respect to prediction data generated based on the motion vector and the video parameter values.

In a further example, the disclosure describes a video coding device comprising means for storing a list of predefined sub-pixels associated with one or more video parameters, means for coding syntax elements indicating at least one motion vector for a video block with respect to a reference block having sub-pixel resolution, and, when the motion vector points to a sub-pixel position of the reference block that is included in the list of predefined sub-pixels, means for coding syntax elements indicating video parameter values associated with the motion vector, and means for coding the video block with respect to prediction data generated based on the motion vector and the video parameter values.

In another example, the disclosure describes a computer-readable storage medium comprising instructions for coding video data that, upon execution in a processor, cause the processor to store a list of predefined sub-pixels associated with one or more video parameters, code syntax elements indicating at least one motion vector for a video block with respect to a reference block having sub-pixel resolution, and when the motion vector points to a sub-pixel position of the reference block that is included in the list of predefined sub-pixels, code syntax elements indicating video parameter values associated with the motion vector, and code the video block with respect to prediction data generated based on the motion vector and the video parameter values.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example video encoding and decoding system that may utilize techniques for efficiently coding video parameter values for weighted motion compensated prediction of a video block.

FIG. 2 is a block diagram illustrating an example video encoder that may implement techniques for efficiently encoding video parameter values for weighted motion compensated prediction of a video block.

FIG. 3 is a block diagram illustrating an example video decoder that may implement techniques for efficiently decoding video parameter values for weighted motion compensated prediction of a video block.

FIG. 4 is a conceptual diagram illustrating pixel positions associated with reference blocks of a reference frame, and sub-pixel positions associated with interpolated versions of one of the reference blocks.

FIG. 5 is a flowchart illustrating an example operation of encoding video blocks using weighted prediction with sub-pixel accuracy.

FIG. 6 is a flowchart illustrating an example operation of decoding video blocks using weighted prediction with sub-pixel accuracy.

### DETAILED DESCRIPTION

This disclosure relates to techniques for efficient coding of video parameters for weighted motion compensated prediction in video coding. A video coding device may code a video block of a video coding unit using weighted motion compensated prediction with respect to prediction data generated based on at least one motion vector and video parameter values associated with the motion vector. The video parameter values may include, for example, a scale parameter value and/or an offset parameter value used to adjust prediction data for the video block to compensate for luminance and/or chrominance changes between the reference block and the video block. The techniques of this disclosure reduce signaling overhead by only coding video parameter values for weighted motion compensated prediction when the motion vector points to a predefined sub-pixel position of a reference block. In this manner, duplicative overhead may be eliminated with respect to motion vectors that point to other sub-pixel positions of the reference block.

More specifically, the techniques include storing a list of predefined sub-pixels associated with one or more video parameters. In this way, when the motion vector points to a sub-pixel position of the reference block that is included in the list of predefined sub-pixels, a video coding device codes video parameter values associated with the motion vector. The video coding device then codes the video block using weighted motion compensated prediction with respect to prediction data generated based on the motion vector and the video parameter values. Moreover, the list of predefined sub-pixels may be signaled to a video decoder at one of a video coding unit level, a video slice level, a video frame level, or a video sequence level.

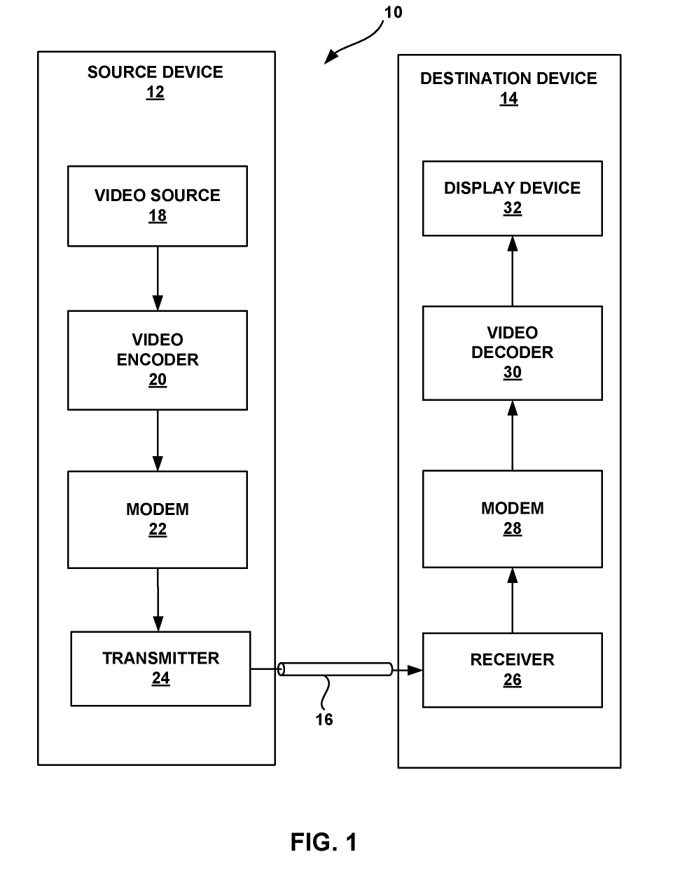

FIG. 1 is a block diagram illustrating an example video encoding and decoding system 10 that may utilize techniques for efficiently coding video parameter values for weighted motion compensated prediction of a video block. The video parameter values may include, for example, a scale parameter value and/or an offset parameter value used to compensate for luminance changes and/or chrominance in a video scene. As shown in FIG. 1, system 10 includes a source device 12 that transmits encoded video to a destination device 14 via a communication channel 16. Source device 12 and destination device 14 may comprise any of a wide range of devices. In some cases, source device 12 and destination device 14 may comprise wireless communication devices that can communicate video information over a communication channel 16, in which case communication channel 16 is wireless.

The techniques of this disclosure, however, which concern efficient coding of video parameter values for weighted motion compensated prediction, are not necessarily limited to wireless applications or settings. For example, these techniques may apply to over-the-air television broadcasts, cable television transmissions, satellite television transmissions, Internet video transmissions, encoded digital video that is encoded onto a storage medium, or other scenarios. Accordingly, communication channel 16 may comprise any combination of wireless or wired media suitable for transmission of encoded video data, and devices 12, 14 may comprise any of a variety of wired or wireless media devices such as mobile telephones, smartphones, digital media players, set-top boxes, televisions, displays, desktop computers, portable computers, tablet computers, gaming consoles, portable gaming devices, or the like.

In the example of FIG. 1, source device 12 includes a video source 18, video encoder 20, a modulator/demodulator (modem) 22 and a transmitter 24. Destination device 14 includes a receiver 26, a modem 28, a video decoder 30, and a display device 32. In other examples, a source device and a destination device may include other components or arrangements. For example, source device 12 may receive video data from an external video source 18, such as an external camera, a video storage archive, a computer graphics source, or the like. Likewise, destination device 14 may interface with an external display device, rather than including an integrated display device.

The illustrated system 10 of FIG. 1 is merely one example. In other examples, any digital video encoding and/or decoding device may perform the disclosed techniques for efficient coding of video parameter values for weighted motion compensated prediction of video blocks. The techniques may also be performed by a video encoder/decoder, typically referred to as a “CODEC.” Moreover, the techniques of this disclosure may also be performed by a video preprocessor. Source device 12 and destination device 14 are merely examples of such coding devices in which source device 12 generates coded video data for transmission to destination device 14. In some examples, devices 12, 14 may operate in a substantially symmetrical manner such that each of devices 12, 14 include video encoding and decoding components. Hence, system 10 may support one-way or two-way video transmission between video devices 12, 14, e.g., for video streaming, video playback, video broadcasting, or video telephony.

Video source 18 of source device 12 may include a video capture device, such as a video camera, a video archive containing previously captured video, and/or a video feed from a video content provider. As a further alternative, video source 18 may generate computer graphics-based data as the source video, or a combination of live video, archived video, and computer-generated video. In some cases, if video source 18 is a video camera, source device 12 and destination device 14 may form so-called camera phones or video phones. As mentioned above, however, the techniques described in this disclosure may be applicable to video coding in general, and may be applied to wireless and/or wired applications. In each case, the captured, pre-captured, or computer-generated video may be encoded by video encoder 20. The encoded video information may then be modulated by modem 22 according to a communication standard, and transmitted to destination device 14 via transmitter 24. Modem 22 may include various mixers, filters, amplifiers or other components designed for signal modulation. Transmitter 24 may include circuits designed for transmitting data, including amplifiers, filters, and one or more antennas.

In accordance with this disclosure, video encoder 20 of source device 12 may be configured to apply the techniques for efficiently coding video parameter values for weighted motion compensated prediction of a video block. More specifically, video encoder 20 may signal video parameter values for weighted motion compensated prediction only with motion vectors that point to a predefined sub-pixel position of a reference block. The video parameter values may include at least one of scale parameter values or offset parameter values used to compensate for luminance and/or chrominance changes in a video scene. According to the techniques, video encoder 20 no longer signals video parameter values to video decoder 30 with every motion vector for every video block of a video frame. The techniques, therefore, reduce signaling overhead and improve coding efficiency.

Video encoder 20 may store a list of predefined sub-pixels associated with one or more video parameter values. When the motion vector points to one of the predefined sub-pixels included in the list, video encoder 20 may encode the video block using weighted motion compensated prediction with respect to prediction data generated based on both the motion vector and the video parameter values. In addition, video encoder 20 may encode syntax elements indicating the motion vector and the video parameter values associated with the motion vector. On the other hand, when the motion vector does not point to one of the predefined sub-pixels in the list, video encoder 20 may encode the video block with respect to a prediction block generated based only on the motion vector, and encode syntax elements indicating only the motion vector. Video encoder 20 also signals the list of predefined sub-pixels to video decoder 30 at one of a video coding unit level, a video slice level, a video frame level, or a video sequence level.

Receiver 26 of destination device 14 receives information over channel 16, and modem 28 demodulates the information. The information communicated over channel 16 may include syntax information defined by video encoder 20, which is also used by video decoder 30, that includes syntax elements that describe characteristics and/or processing of prediction units (PUs), coding units (CUs) or other units of coded video, e.g., video slices, video frames, and video sequences or groups of pictures (GOPs). Display device 32 displays the decoded video data to a user, and may comprise any of a variety of display devices such as a cathode ray tube (CRT), a liquid crystal display (LCD), a plasma display, an organic light emitting diode (OLED) display, or another type of display device.

In accordance with this disclosure, video decoder 30 of destination device 14 may be configured to apply the techniques for efficiently coding video parameter values for weighted motion compensated prediction of video blocks. More specifically, video decoder 30 only decodes video parameter values for weighted motion compensated prediction when at least one decoded motion vector points to a predefined sub-pixel position of a reference block. Video decoder 30 receives a list of predefined sub-pixels signaled from video encoder 20. In this way, video decoder 30 knows when to expect syntax elements indicating video parameter values associated with the motion vector. Video decoder 30 may then perform a reciprocal decoding of the video blocks with or without video parameter values.

When a decoded motion vector for a video block points to one of the predefined sub-pixels included in the list, video decoder 30 may expect to receive video parameter values associated with the motion vector, and decodes the expected syntax elements indicating the video parameter values. Video decoder 30 may then decode the video block using weighted motion compensated prediction with respect to prediction data generated based on both the motion vector and the video parameter values. On the other hand, when the decoded motion vector does not point to one of the predefined sub-pixels in the list, video decoder 30 will not expect to receive any video parameter values and may decode the video block with respect to a prediction block generated based only on the motion vector.

In the example of FIG. 1, communication channel 16 may comprise any wireless or wired communication medium, such as a radio frequency (RF) spectrum or one or more physical transmission lines, or any combination of wireless and wired media. Communication channel 16 may form part of a packet-based network, such as a local area network, a wide-area network, or a global network such as the Internet. Communication channel 16 generally represents any suitable communication medium, or collection of different communication media, for transmitting video data from source device 12 to destination device 14, including any suitable combination of wired or wireless media. Communication channel 16 may include routers, switches, base stations, or any other equipment that may be useful to facilitate communication from source device 12 to destination device 14.

Video encoder 20 and video decoder 30 may operate according to a video compression standard, such as the emerging High Efficiency Video Coding (HEVC) standard or the ITU-T H.264 standard, alternatively referred to as MPEG-4, Part 10, Advanced Video Coding (AVC). The techniques of this disclosure, however, are not limited to any particular coding standard. Other examples include MPEG-2 and ITU-T H.263. Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, MUX-DEMUX units may conform to the ITU H.223 multiplexer protocol, or other protocols such as the user datagram protocol (UDP).

The HEVC standardization efforts are based on a model of a video coding device referred to as the HEVC Test Model (HM). The HM presumes several additional capabilities of video coding devices relative to existing devices according to, e.g., ITU-T H.264/AVC. The HM refers to a block of video data as a coding unit (CU). Syntax data within a bitstream may define a largest coding unit (LCU), which is a largest coding unit in terms of the number of pixels. In general, a CU has a similar purpose to a macroblock of the H.264 standard, except that a CU does not have a size distinction. Thus, a CU may be split into sub-CUs. In general, references in this disclosure to a CU may refer to a largest coding unit of a picture or a sub-CU of an LCU. An LCU may be split into sub-CUs, and each sub-CU may be further split into sub-CUs. Syntax data for a bitstream may define a maximum number of times an LCU may be split, referred to as CU depth. Accordingly, a bitstream may also define a smallest coding unit (SCU).

A CU that is not further split (i.e., a leaf node of an LCU) may include one or more prediction units (PUs). In general, a PU represents all or a portion of the corresponding CU, and includes data for retrieving a reference sample for the PU. For example, when the PU is intra-mode encoded, the PU may include data describing an intra-prediction mode for the PU. As another example, when the PU is inter-mode encoded, the PU may include data defining a motion vector for the PU. The data defining the motion vector may describe, for example, a horizontal component of the motion vector, a vertical component of the motion vector, a resolution for the motion vector (e.g., one-half pixel precision, one-quarter pixel precision, or one-eighth pixel precision), a reference frame to which the motion vector points, and/or a reference frame list (e.g., List 0 or List 1) for the motion vector. Data for the CU defining the PU(s) may also describe, for example, partitioning of the CU into one or more PUs. Partitioning modes may differ between whether the CU is skip or direct mode encoded, intra-prediction mode encoded, or inter-prediction mode encoded.

A CU having one or more PUs may also include one or more transform units (TUs). Following prediction using a PU, a video encoder may calculate residual values for the portion of the CU corresponding to the PU. The residual values correspond to pixel difference values that may be transformed into transform coefficients quantized, and scanned to produce serialized transform coefficients for entropy coding. A TU is not necessarily limited to the size of a PU. Thus, TUs may be larger or smaller than corresponding PUs for the same CU. In some examples, the maximum size of a TU may be the size of the corresponding CU. This disclosure uses the term “video block” to refer to any of a CU, PU, or TU.

Video encoder 20 and video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. Each of video encoder 20 and video decoder 30 may be included in one or more encoders or decoders, either of which may be integrated as part of a combined encoder/decoder (CODEC) in a respective camera, computer, mobile device, subscriber device, broadcast device, set-top box, server, or the like.

A video sequence or group of pictures (GOP) typically includes a series of video frames. A GOP may include syntax data in a header of the GOP, a header of one or more frames of the GOP, or elsewhere, that describes a number of frames included in the GOP. Each frame may include frame syntax data that describes an encoding mode for the respective frame. Video encoder 20 typically operates on video blocks within individual video frames in order to encode the video data. A video block may correspond to a coding unit (CU) or a partition unit (PU) of the CU. The video blocks may have fixed or varying sizes, and may differ in size according to a specified coding standard. Each video frame may include a plurality of slices. Each slice may include a plurality of CUs, which may include one or more PUs.

As an example, the HEVC Test Model (HM) supports prediction in various CU sizes. The size of an LCU may be defined by syntax information. Assuming that the size of a particular CU is 2N×2N, the HM supports intra-prediction in sizes of 2N×2N or N×N, and inter-prediction in symmetric sizes of 2N×2N, 2N×N, N×2N, or N×N. The HM also supports asymmetric splitting for inter-prediction of 2N×nU, 2N×nD, nL×2N, and nR×2N. In asymmetric splitting, one direction of a CU is not split, while the other direction is split into 25% and 75%. The portion of the CU corresponding to the 25% split is indicated by an “n” followed by an indication of “Up”, “Down,” “Left,” or “Right.” Thus, for example, “2N×nU” refers to a 2N×2N CU that is split horizontally with a 2N×0.5N PU on top and a 2N×1.5N PU on bottom.

In this disclosure, “N×N” and “N by N” may be used interchangeably to refer to the pixel dimensions of a video block (e.g., CU, PU, or TU) in terms of vertical and horizontal dimensions, e.g., 16×16 pixels or 16 by 16 pixels. In general, a 16×16 block will have 16 pixels in a vertical direction (y=16) and 16 pixels in a horizontal direction (x=16). Likewise, an N×N block generally has N pixels in a vertical direction and N pixels in a horizontal direction, where N represents a nonnegative integer value. The pixels in a block may be arranged in rows and columns. Moreover, blocks need not necessarily have the same number of pixels in the horizontal direction as in the vertical direction. For example, blocks may comprise N×M pixels, where M is not necessarily equal to N.

Following intra-predictive or inter-predictive coding to produce a PU for a CU, video encoder 20 may calculate residual data to produce one or more transform units (TUs) for the CU. PUs of a CU may comprise pixel data in the spatial domain (also referred to as the pixel domain), while TUs of the CU may comprise coefficients in the transform domain, e.g., following application of a transform such as a discrete cosine transform (DCT), an integer transform, a wavelet transform, or a conceptually similar transform to residual video data. The residual data may correspond to pixel differences between pixels of the unencoded picture and prediction values of a PU of a CU. Video encoder 20 may form one or more TUs including the residual data for the CU. Video encoder 20 may then transform the TUs.

Following any transforms to produce transform coefficients, quantization of transform coefficients may be performed. Quantization generally refers to a process in which transform coefficients are quantized to possibly reduce the amount of data used to represent the coefficients. The quantization process may reduce the bit depth associated with some or all of the coefficients. For example, an n-bit value may be rounded down to an m-bit value during quantization, where n is greater than m.

In some examples, video encoder 20 may utilize a predefined scan order to scan the quantized transform coefficients to produce a serialized vector that can be entropy encoded. In other examples, video encoder 20 may perform an adaptive scan. After scanning the quantized transform coefficients to form a one-dimensional vector, video encoder 20 may entropy encode the one-dimensional vector, e.g., according to context adaptive variable length coding (CAVLC), context adaptive binary arithmetic coding (CABAC), syntax-based context-adaptive binary arithmetic coding (SBAC), or another entropy encoding methodology.

To perform CABAC, video encoder 20 may select a context model to apply to a certain context to encode symbols to be transmitted. The context may relate to, for example, whether neighboring values are non-zero or not. To perform CAVLC, video encoder 20 may select a variable length code for a symbol to be transmitted. Codewords in VLC may be constructed such that relatively shorter codes correspond to more probable symbols, while longer codes correspond to less probable symbols. In this way, the use of VLC may achieve a bit savings over, for example, using equal-length codewords for each symbol to be transmitted. The probability determination in CAVLC may be based on the context of the symbols.

Video encoder 20 may also entropy encode syntax elements indicating prediction information. In accordance with this disclosure, video encoder 20 may entropy encode syntax elements indicating a list of predefined sub-pixels at one of the CU level, the slice level, the frame level, or the sequence level. Video encoder 20 may also entropy encode syntax elements indicating at least one motion vector for each inter-coded video block or PU and, when the motion vector points to one of the predefined sub-pixels, entropy encode syntax elements indicating video parameter values associated with the motion vector. Video encoder 20 may also entropy encode syntax elements indicating one or more interpolation filters used to calculate sub-pixel positions of reference frames.

Video decoder 30 may operate in a manner essentially symmetrical to that of video encoder 20. For example, video decoder 30 may decode syntax elements indicating the list of predefined sub-pixels at one of the CU level, the slice level, the frame level, or the sequence level, and store the list. Video decoder 30 may decode syntax elements indicating one or more interpolation filters used by video encoder 20 to calculate sub-pixel positions of reference frames. Video decoder 30 may then decode syntax elements indicating at least one motion vector for each inter-coded video block or PU. When the motion vector points to one of the predefined sub-pixels, video decoder 30 expects to receive video parameter values associated with the motion vector, and decodes the expected syntax elements indicating the video parameter values.

In this way, video encoder 20 does not need to signal video parameter values to video decoder 30 with every motion vector for every video block of a frame. By limiting the signaling of video parameter values for weighted motion compensated prediction to only those motion vectors that point to predefined sub-pixels, the techniques can reduce signaling overhead and improve coding efficiency.

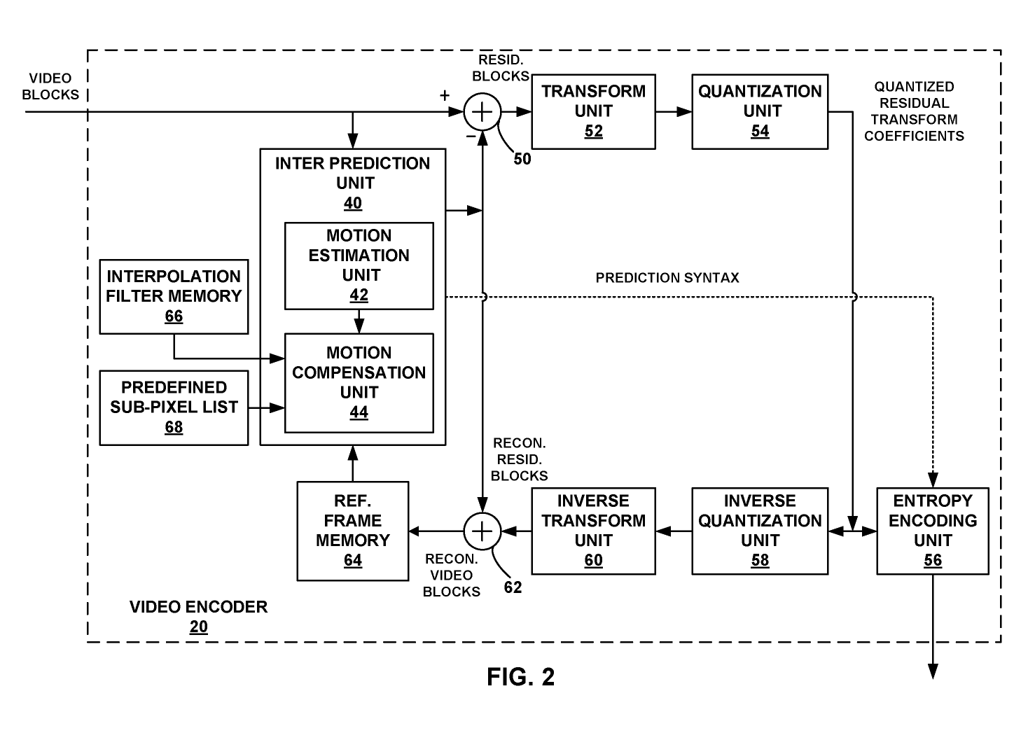

FIG. 2 is a block diagram illustrating an example of video encoder 20 that may implement techniques for efficiently coding video parameter values for weighted motion compensated prediction of video blocks. Video encoder 20 may perform intra- and inter-coding of coding units within video frames. Intra-coding relies on spatial prediction to reduce or remove spatial redundancy in video within a given video frame. Inter-coding relies on temporal prediction to reduce or remove temporal redundancy in video within adjacent frames of a video sequence. Intra-mode (I mode) may refer to any of several spatial based compression modes. Inter-modes such as unidirectional prediction (P mode), bidirectional prediction (B mode), or generalized P/B prediction (GPB mode) may refer to any of several temporal-based compression modes.

In the example of FIG. 2, video encoder 20 includes prediction unit 40, summer 50, transform unit 52, quantization unit 54, entropy encoding unit 56, reference frame memory 64, interpolation filter memory 66, and predefined sub-pixel list 68. Prediction unit 40 includes motion estimation unit 42 and motion compensation unit 44. In other examples, prediction unit 40 may also include an intra prediction unit (not shown in FIG. 2) to perform intra-predictive coding of a video block relative to one or more neighboring blocks in the same frame as the video block to be coded. For video block reconstruction, video encoder 20 also includes inverse quantization unit 58, inverse transform unit 60, and summer 62. A deblocking filter (not shown in FIG. 2) may also be included to filter block boundaries to remove blockiness artifacts from reconstructed video. If desired, the deblocking filter would typically filter the output of summer 62.

As shown in FIG. 2, video encoder 20 receives a video block within a video frame or slice to be encoded. The frame or slice may be divided into multiple video blocks or CUs. Prediction unit 40 may select one of the coding modes, intra or inter, for the video block based on error results, and provide the resulting intra- or inter-coded predictive block to summer 50 to generate residual block data, and to summer 62 to reconstruct the encoded block for use as a reference block in a reference frame.

Motion estimation unit 42 and motion compensation unit 44 within prediction unit 40 perform inter-predictive coding of the video block with respect to one or more reference blocks in one or more reference frames stored in reference frame memory 64. Motion estimation unit 42 and motion compensation unit 44 may be highly integrated, but are illustrated separately for conceptual purposes. Motion estimation, performed by motion estimation unit 42, is the process of generating motion vectors, which estimate motion for video blocks. A motion vector, for example, may indicate the displacement of a video block or PU within a current video frame relative to a reference block of PU within a reference frame. A reference block is a block that is found to closely match the video block or PU to be coded in terms of pixel difference, which may be determined by sum of absolute difference (SAD), sum of square difference (SSD), or other difference metrics.

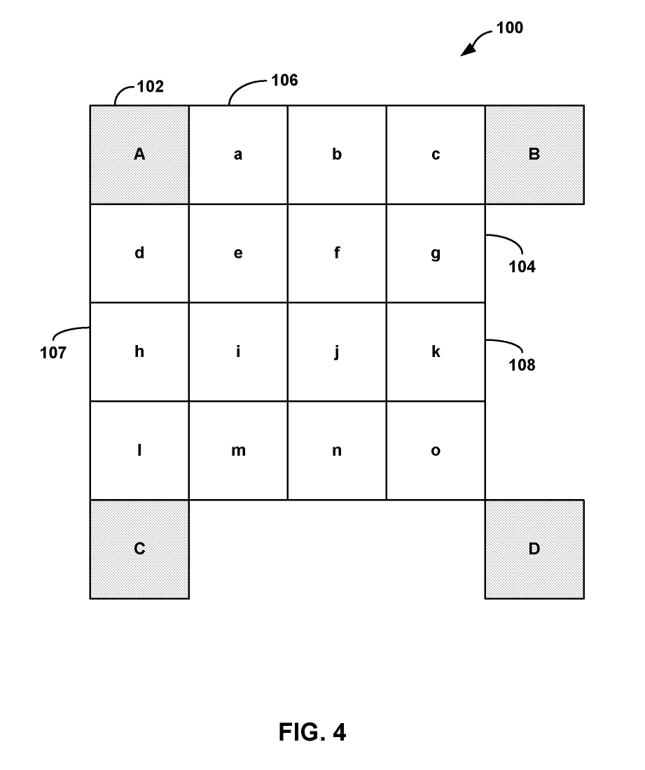

In some examples, video encoder 20 may use one or more interpolation filters stored in interpolation filter memory 66 to calculate values for sub-pixel positions of reference frames stored in reference frame memory 64 to provide higher precision motion compensation. For example, video encoder 20 may calculate values of one-half pixel position, one-quarter pixel positions, one-eighth pixel positions, or other fractional pixel positions of the reference frames. In one example, motion compensation unit 44 may use adaptive interpolation filtering of a reference frame to generate the sub-pixel values. In another example, motion compensation unit 44 may apply several sets of fixed interpolation filters from interpolation filter memory 66 to a reference frame to generate several different interpolated versions of the reference frame. Interpolation techniques are described in more detail below with reference to FIG. 4.

Motion estimation unit 42, therefore, may select a motion vector for the video block to be coded with respect to a reference block having sub-pixel resolution. In this case, motion estimation unit 42 may compare the video block to be coded with several different versions of the interpolated reference block, and select a motion vector that points to the sub-pixel position of the reference block that defines the best prediction data.

Motion estimation unit 42 sends the calculated motion vector to entropy encoding unit 56 and motion compensation unit 44. Motion compensation, performed by motion compensation unit 44, may involve fetching or generating the predictive block based on the motion vector determined by motion estimation. In the case of weighted motion compensated prediction, motion compensation unit 44 may first generate an initial predictive block based on the motion vector, and then adjust the initial predictive block based on video parameter values to generate the predictive block for coding the video block. The video parameter values may comprise scale parameter values and/or offset parameter values used to compensate for luminance and/or chrominance changes. Video encoder 20 forms a residual video block by subtracting the predictive block from the video block being coded. Summer 50 represents the component or components that perform this subtraction operation.

In the H.264/AVC standard and the emerging HEVC standard, weighted motion compensated prediction allows scale parameter values and/or offset parameter values to be added to the pixel values of predictive blocks for use in coding video blocks. Adding scale parameter values and/or offset parameter values to the prediction data can help to capture effects of illumination changes between a reference block and the video block to be coded. Scale parameter values and offset parameter values may be used during a transition period of a chrominance effect or a luminance effect, such as a cross-fade, fade-in, fade-out, flash, or the like, that occurs over several frames. For example, a scale, i.e., weight, parameter value may compensate for a luminance and/or chrominance change by increasing or decreasing the luminance and/or chrominance value at each pixel of a predictive block by a percentage indicated by the scale parameter value. An offset, i.e., DC, parameter value may compensate for a luminance and/or chrominance change by increasing or decreasing the luminance and/or chrominance values at all the pixels of a predictive block by a common amount indicated by the offset parameter value.

In the H.264/AVC standard, weighted motion compensated prediction is typically performed at the video frame level such that each video frame may have only one scale and/or offset parameter value. In the HEVC standard, weighted motion compensated prediction is typically performed at the video coding unit level such that each CU of a video frame may have only one scale and/or offset parameter value. In the above cases, the video parameter values signaled to video decoder 30 with each motion vector, therefore, may be the same for a given frame or CU.

As an example, a predictive block generated for unidirectional motion compensated prediction may be represented as either:

pred(i,j)=pred0(i,j), or

pred(i,j)=pred1(i,j),

where (i, j) identifies a pixel or sub-pixel position of a reference block to which a motion vector points, pred0 (i, j) represents prediction data from a pixel or sub-pixel position (i, j) of a reference block in a reference frame from list 0, and pred1(i, j) represents prediction data from a pixel or sub-pixel position (i, j) of a reference block in a reference frame from list 1. A predictive block generated for bidirectional motion compensated prediction may be represented as:

pred(i,j)=(pred0(i,j)+pred1(i,j)+1)>>1,

where (>>1) represents a right shift by 1 bit. In this case, the predictive block is generated based on a combination of prediction data from pixel or sub-pixel positions (i, j) of reference blocks in reference frames from both list 0 and list 1, as indentified by two motion vectors.

As another example, a predictive block generated for unidirectional weighted motion compensated prediction, with scale and offset parameter values, may be represented as either:

pred(i,j)=pred0(i,j)*Scale0+Offset0, or

pred(i,j)=pred1(i,j)*Scale1+Offset1,

where Scale0 and Offset0 represent video parameter values applied to the prediction data generated based on a motion vector pointing to list 0, and Scale1 and Offset1 represent video parameter values applied to the prediction data generated based on a motion vector pointing to from list 1. A predictive block generated for bidirectional weighted motion compensated prediction, with scale and offset parameter values, may be represented as:

pred(i,j)=(pred0(i,j)*Scale0+pred1(i,j)*Scale1+Offset0+Offset1)>>1.

In this case, the predictive block is generated based on a combination of prediction data from pixel or sub-pixel positions (i, j) of reference blocks in reference frames from both list 0 and list 1, as indentified by two motion vectors, and video parameter values associated with the two motion vectors.

Motion compensation unit 44 may generate syntax elements defined to represent prediction information at one or more of a video sequence level, a video frame level, a video slice level, a video coding unit (CU) level, or a video prediction unit (PU) level. For example, motion compensation unit 44 may generate syntax elements indicating motion vectors and, in the case of weighted motion compensated prediction, video parameter values associated with the motion vectors for each video block or PU. Signaling video parameter values with every motion vector for every video block or PU of a video frame, however, creates substantial signaling overhead and does not provide any coding efficiency advantage.

According to the techniques of this disclosure, motion compensation unit 44 may only generate syntax elements indicating video parameter values for weighted motion compensated prediction when at least one motion vector for the video block points to a predefined sub-pixel of the reference block. In this way, video encoder 20 no longer signals video parameter values to video decoder 30 with every motion vector for every video block of a frame. By limiting the signaling of video parameter values for weighted motion compensated prediction to only those motion vectors that point to predefined sub-pixels, the techniques reduce signaling overhead and improve coding efficiency.

Video encoder 20 may store one or more predefined sub-pixels in predefined sub-pixel list 68. More specifically, predefined sub-pixel list 68 may include one more predefined sub-pixel positions of a reference block at which video parameter values may be applied to compensate for a luminance and/or chrominance change between the reference block and the video block to be coded. The video parameter values may include scale parameter values and/or offset parameter values.

Predefined sub-pixel list 68 may be used to define sub-pixel positions for weighted motion compensation for all video blocks in a CU, a video slice, a video frame, or a video sequence. In some cases, predefined sub-pixel list 68 may be generated prior to encoding based on current or historical data regarding luminance and/or chrominance changes in a CU, a video slice, a video frame, or a video sequence. In some examples, predefined sub-pixel list 68 may include a single list for the one or more video parameters. In this case, scale and offset parameters may be applied to prediction data for the same sub-pixel positions of reference frames. In other examples, predefined sub-pixel list 68 may include multiple lists, one for each of the video parameters. In this case, predefined sub-pixel list 68 may comprise a first list associated with a scale parameter and a second list associated with an offset parameter. In some examples, the scale parameters may be applied to prediction data for different sub-pixel positions of reference frames than the offset parameters.

Motion compensation unit 44 may generate syntax elements to signal the predefined sub-pixels included in predefined sub-pixel list 68 to video decoder 30. The predefined sub-pixels may be signaled at one of the CU level, the slice level, the frame level, or the sequence level. Signaling the predefined sub-pixels enables video decoder 30 to know when to expect video parameter values associated with decoded motion vectors. Video decoder 30 may then properly parse the syntax elements for video blocks and accurately decode the video blocks with or without video parameter values.

In accordance with the disclosed techniques, when motion compensation unit 44 receives a motion vector for a video block from motion estimation unit 42, motion compensation unit 44 determines whether the motion vector points to a sub-pixel position of the reference block that is included in the predefined sub-pixel list 68. Motion compensation unit 44 only generates syntax elements indicating video parameter values for weighted motion compensated prediction when the motion vector points to a predefined sub-pixel in list 68. In this way, video encoder 20 only signals video parameter values to video decoder 30 with motion vectors that point to one of the predefined sub-pixels.

When a motion vector points to one of the predefined sub-pixels in list 68, motion compensation unit 44 generates a predictive block based on both the motion vector and the video parameter values associated with the motion vector. More specifically, motion compensation unit 44 generates an initial predictive block from the reference block based on the motion vector, and then adjusts the initial predictive block based on the video parameter values associated with the motion vector. For example, motion compensation unit 44 may apply at least one of a scale parameter value and an offset parameter value to the initial predictive block to compensate for a luminance and/or chrominance change between the reference block and the video block to be encoded. Video encoder 20 then forms a residual video block by subtracting the predictive block generated based on the motion vector and the video parameter values from the video block in order to encode the video block. Motion compensation unit 44 generates syntax elements indicating the motion vector and the video parameter values associated with the motion vector for encoding by entropy encoding unit 56.

On the other hand, when the motion vector points to a sub-pixel position of the reference block that is not included in predefined sub-pixel list 68, motion compensation unit 44 generates a predictive block based only on the motion vector. Video encoder 20 then forms a residual video block by subtracting the predictive block generated based on the motion vector from the video block in order to encode the video block. Motion compensation unit 44 also generates syntax elements indicating the motion vector for encoding by entropy encoding unit 56. In this case, however, motion compensation unit 44 does not generate syntax elements indicating video parameter values for signaling to video decoder 30. In accordance with the techniques, video encoder 20 does not encode video parameter values with every motion vector for every video block of a frame, which reduces signaling overhead and improves coding efficiency.

In some cases, video encoder 20 may encode a video block using the bidirectional prediction mode such that motion estimation unit 42 may select a first motion vector from list 0 and a second motion vector from list 1. In that case, motion compensation unit 44 may determine whether each of the motion vectors points to a sub-pixel position of the respective reference frame that is included in predefined sub-pixel list 68. According to the techniques, video encoder 20 may only encode video parameter values associated with the first motion vector when the first motion vector points to one of the predefined sub-pixels in list 68. Furthermore, video encoder 20 may only encode video parameter values associated with the second motion vector when the second motion vector points to one of the predefined sub-pixels in list 68.

In other cases, video encoder 20 may store separate predefined sub-pixel lists associated with a scale parameter and an offset parameter. Motion compensation unit 44 may then determine whether the motion vector points to a sub-pixel position of the reference frame that is included in either a first list associated with the scale parameter or a second list associated with the offset parameter. According to the techniques, video encoder 20 may only encode a scale parameter value associated with the motion vector when the motion vector points to a predefined sub-pixel in the first predefined sub-pixel list. Moreover, video encoder 20 may only encode an offset parameter value associated with the motion vector when the motion vector points to a predefined sub-pixel in the second predefined sub-pixel list. The first and second sub-pixel lists may include at least some different sub-pixel positions.

After video encoder 20 forms the residual video block by subtracting the predictive block from the current video block, transform unit 52 may form one or more transform units (TUs) from the residual block. Transform unit 52 applies a transform, such as a discrete cosine transform (DCT) or a conceptually similar transform, to the TU, producing a video block comprising residual transform coefficients. The transform may convert the residual block from a pixel domain to a transform domain, such as a frequency domain.

Transform unit 52 may send the resulting transform coefficients to quantization unit 54. Quantization unit 54 quantizes the transform coefficients to further reduce bit rate. The quantization process may reduce the bit depth associated with some or all of the coefficients. The degree of quantization may be modified by adjusting a quantization parameter. In some examples, quantization unit 54 may then perform a scan of the matrix including the quantized transform coefficients. Alternatively, entropy encoding unit 56 may perform the scan.

Following quantization, entropy encoding unit 56 entropy codes the quantized transform coefficients. For example, entropy encoding unit 56 may perform context adaptive variable length coding (CAVLC), context adaptive binary arithmetic coding (CABAC), or another entropy encoding technique. Following the entropy encoding by entropy encoding unit 56, the encoded bitstream may be transmitted to a video decoder, such as video decoder 30, or archived for later transmission or retrieval.

Entropy encoding unit 56 may also entropy encode the syntax elements indicating the motion vectors and the other prediction information for the video block being coded. For example, entropy encoding unit 56 may construct header information that includes appropriate syntax elements generated by motion compensation unit 44 for transmission in the encoded bitstream. In accordance with this disclosure, video encoder 20 may entropy encode syntax elements indicating a list of predefined sub-pixels at one of the CU level, the slice level, the frame level, or the sequence level. Video encoder 20 may also entropy encode syntax elements indicating at least one motion vector for each inter-coded video block or PU and, when the motion vector points to one of the predefined sub-pixels, syntax elements indicating video parameter values associated with the motion vector. Video encoder 20 may also entropy encode syntax elements indicating one or more interpolation filters used to calculate sub-pixel positions of reference frames.

To entropy encode the syntax elements, entropy encoding unit 56 may perform CABAC and binarize the syntax elements into one or more binary bits based on a context model. Entropy encoding unit may also perform CAVLC and encode the syntax elements as codewords according to probabilities based on context.

Inverse quantization unit 58 and inverse transform unit 60 apply inverse quantization and inverse transformation, respectively, to reconstruct the residual block in the pixel domain for later use as a reference block of a reference frame. Motion compensation unit 44 may apply one or more interpolation filters from interpolation filter memory 66 to the reconstructed residual block to calculate sub-pixel positions of the reconstructed residual block for use in motion estimation. Summer 62 adds the reconstructed residual block to the predictive block generated by motion compensation unit 44 to produce a reference block for storage in reference frame memory 64. The reference block may be used by motion estimation unit 42 and motion compensation unit 44 as a reference block to inter-predict a block in a subsequent video frame.

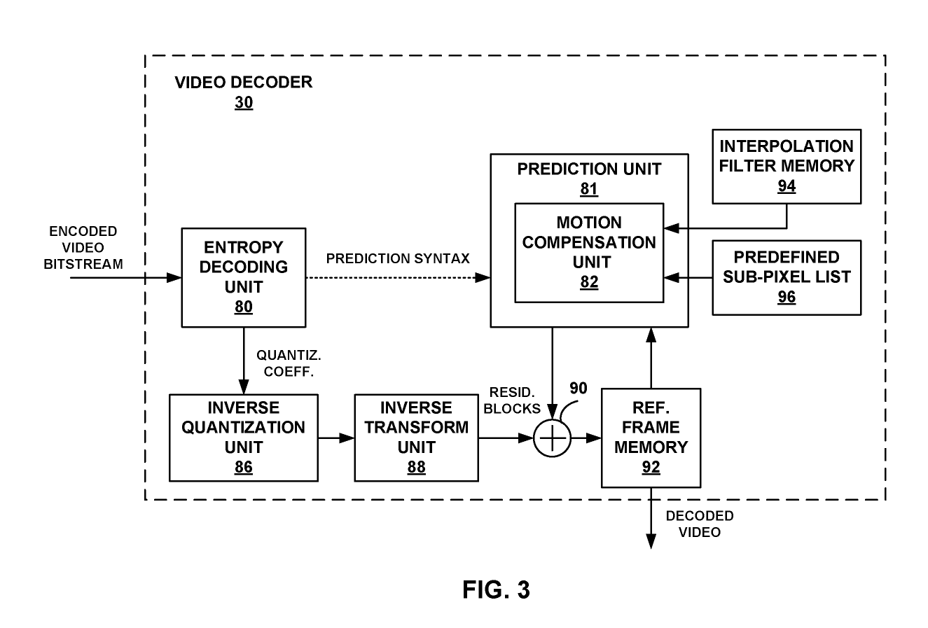

FIG. 3 is a block diagram illustrating an example of video decoder 30 that may implement techniques for efficiently coding video parameter values for weighted motion compensated prediction of video blocks. In the example of FIG. 3, video decoder 30 includes an entropy decoding unit 80, prediction unit 81, inverse quantization unit 86, inverse transformation unit 88, summer 90, reference frame memory 92, interpolation filter memory 94, and predefined sub-pixel list 96. Prediction unit 81 includes motion compensation unit 82. In other examples, prediction unit 81 may include an intra prediction unit (not shown in FIG. 3) to generate prediction data for a video block of the current video frame based on a signaled intra prediction mode and data from previously decoded blocks of the current frame. Video decoder 30 may, in some examples, perform a decoding pass generally reciprocal to the encoding pass described with respect to video encoder 20 (FIG. 2).

During the decoding process, video decoder 30 receives an encoded video bitstream that includes an encoded video frames or slices and syntax elements that represent coding information from video encoder 20. Entropy decoding unit 80 entropy decodes the bitstream to generate quantized coefficients, motion vectors, and other prediction syntax elements. Entropy decoding unit 80 forwards the motion vectors and other prediction syntax elements to prediction unit 81. Video decoder 30 may receive the syntax elements at the video prediction unit level, the video coding unit level, the video slice level, the video frame level, and/or the video sequence level.

When a video frame is coded as an inter-coded frame, motion compensation unit 82 of prediction unit 81 produces predictive blocks for video block of the video frame based on the decoded motion vectors received from entropy decoding unit 80. The predictive blocks may be generated with respect to one or more reference blocks of a reference frame stored in reference frame memory 92. In the case of weighted motion compensated prediction, motion compensation unit 82 may apply video parameter values associated with the decoded motion vectors to adjust the predictive blocks to accurately decode the video blocks.

As described above, in the H.264/AVC standard and the emerging HEVC standard, weighted motion compensated prediction allows scale parameter values and/or offset parameter values to be added to the pixel values of predictive blocks for use in coding video blocks. Adding scale parameter values and/or offset parameter values to the prediction data can help to capture effects of illumination changes between a reference block and the video block to be coded. In the H.264/AVC standard, weighted motion compensated prediction is typically performed at the video frame level. In the HEVC standard, weighted motion compensated prediction is typically performed at the video coding unit (CU) level. In the above cases, the video parameter values signaled to video decoder 30 with each motion vector, therefore, may be the same for a given frame or CU.

Motion compensation unit 82 determines prediction information for a video block to be decoded by parsing the motion vectors and other prediction syntax, and uses the prediction information to generate and adjust the predictive blocks for the current video block being decoded. For example, motion compensation unit 82 uses some of the received syntax elements to determine sizes of CUs used to encode the current frame, split information that describes how each CU of the frame is split, modes indicating how each split is encoded (e.g., intra- or inter-prediction), an inter-prediction slice type (e.g., B slice, P slice, or GPB slice), reference frame list construction commands, interpolation filters applied to reference frames, motion vectors for each video block of the frame, video parameter values associated with the motion vectors, and other information to decode the current video frame.

In accordance with the techniques of this disclosure, motion compensation unit 82 may decode syntax elements indicating a list of predefined sub-pixels at one of the CU level, the slice level, the frame level, or the sequence level. Motion compensation unit 82 may then store the predefined sub-pixels as predefined sub-pixel list 96. Predefined sub-pixel list 96 may be used to define sub-pixel positions for weighted motion compensation in a CU, a video slice, a video frame, or a video sequence. In some examples, predefined sub-pixel list 96 may include a single list for the one or more video parameters. In this case, scale and offset parameters may be applied to prediction data for the same sub-pixel positions of reference frames. In other examples, predefined sub-pixel list 96 may include multiple lists, one for each of the video parameters. In this case, predefined sub-pixel list 96 may comprise a first list associated with a scale parameter and a second list associated with an offset parameter. The scale and offset parameters may be applied to prediction data for different sub-pixel positions of reference frames.

Motion compensation unit 82 may also decode syntax elements indicating one or more interpolation filters stored in interpolation filter memory 94 used by video encoder 20. Motion compensation unit 82 may then apply the signaled interpolation filters to calculate sub-pixel positions of reference frames stored in reference frame memory 92. For example, motion compensation unit 82 may calculate values of one-half pixel position, one-quarter pixel positions, one-eighth pixel positions, or other fractional pixel positions of the reference frames.

Motion compensation unit 82 may further decode syntax elements indicating at least one motion vector for each inter-coded video block or PU of the video frame to be decoded. Motion compensation unit 82 determines whether the motion vector points to a sub-pixel position of the reference block that is included in the predefined sub-pixel list 96. Motion compensation unit 82 only expects to decode syntax elements indicating video parameter values for weighted motion compensated prediction when the motion vector points to a predefined sub-pixel in list 96. In this way, video decoder 30 only receives video parameter values signaled from video encoder 20 with motion vectors that point to one of the predefined sub-pixels.

When the motion vector points to one of the predefined sub-pixels in list 96, motion compensation unit 82 expects to receive video parameter values associated with the motion vector. Motion compensation unit 82 may then properly parse the prediction syntax elements and decode the expected syntax elements indicating the video parameter values. Motion compensation unit 82 then generates the predictive block based on the motion vector and the video parameter values associated with the motion vector. More specifically, motion compensation unit 82 generates an initial predictive block from the reference block based on the decoded motion vector, and then adjusts the initial predictive block based on the video parameter values associated with the motion vector. For example, motion compensation unit 82 may apply at least one of a scale parameter value and an offset parameter value to the initial predictive block to compensate for a luminance and/or chrominance change between the reference block and the video block to be decoded. Video decoder 30 then decodes the video block using weighted motion compensated prediction with respect to the predictive block generated based on both the motion vector and the video parameter values.

On the other hand, when the motion vector does not point to one of the predefined sub-pixels in list 96, motion compensation unit 82 generates a predictive block based only on the motion vector. In this case, motion compensation unit 82 does not expect to receive video parameter values associated with the motion vector, and will not attempt to parse the prediction syntax elements for video parameter values. In accordance with the techniques, video decoder 30 does not receive video parameter values signaled from video encoder 20 with every motion vector for every video block of a frame, which reduces signaling overhead and improves coding efficiency. Video decoder 30 then decodes the video block with respect to the predictive block generated based only on the motion vector.

In some cases, video decoder 30 may decode a first motion vector from list 0 and a second motion vector from list 1 for a video block to be decoded using the bidirectional prediction mode. In that case, motion compensation unit 82 may determine whether each of the motion vectors points to a sub-pixel position of the respective reference frame that is included in predefined sub-pixel list 96. According to the techniques, video decoder 30 may only expect to receive and decode video parameter values associated with the first motion vector when the first motion vector points to one of the predefined sub-pixels in list 96. Furthermore, video decoder 30 may only expect to receive and decode video parameter values associated with the second motion vector when the second motion vector points to one of the predefined sub-pixels in list 96.

In other cases, video decoder 30 may receive and store separate predefined sub-pixel lists associated with a scale parameter and an offset parameter. Motion compensation unit 82 may then determine whether the decoded motion vector points to a sub-pixel position of the reference frame that is included in either a first list associated with the scale parameter or a second list associated with the offset parameter. According to the techniques, video decoder 30 may only expect to receive and decode a scale parameter value associated with the motion vector when the motion vector points to a predefined sub-pixel in the first predefined sub-pixel list. Moreover, video decoder 30 may only expect to receive and decode an offset parameter value associated with the motion vector when the motion vector points to a predefined sub-pixel in the second predefined sub-pixel list. The first and second sub-pixel lists may include at least some different sub-pixel positions.

Inverse quantization unit 86 inverse quantizes, i.e., de-quantizes, the quantized transform coefficients provided in the bitstream and decoded by entropy decoding unit 80. The inverse quantization process may include use of a quantization parameter QP calculated by video encoder 20 for each video block or CU to determine a degree of quantization and, likewise, a degree of inverse quantization that should be applied. Inverse transform unit 88 applies an inverse transform, e.g., an inverse DCT, an inverse integer transform, or a conceptually similar inverse transform process, to the transform coefficients in order to produce residual blocks in the pixel domain.

Video decoder 30 forms a decoded video block by summing the residual blocks from inverse transform unit 88 with the corresponding predictive blocks generated by motion compensation unit 82. Summer 90 represents the component or components that perform this summation operation. If desired, a deblocking filter may also be applied to filter the decoded blocks in order to remove blockiness artifacts. The decoded video blocks are then stored in reference frames in reference frame memory 92, which provides reference blocks of reference frames for subsequent motion compensation. Reference frame memory 92 also produces decoded video for presentation on a display device, such as display device 32 of FIG. 1.

FIG. 4 is a conceptual diagram illustrating pixel positions associated with a portion of a reference block 100, and sub-pixel positions associated with interpolated versions of the reference block 100. In the conceptual illustration of FIG. 4, the different boxes represent pixels. Capitalized letters (in the shaded boxes) represent pixel positions, and small letters represent sub-pixel positions.

In the example of FIG. 4, every pixel position has an associated 15 different sub-pixel positions. The 15 different sub-pixel positions associated with pixel position “A” 102 are illustrated as sub-pixel positions “a,” “b,” “c,” “d,” “e,” “f,” “g,” “h,” “i,” “j,” “k,” “1,” “m,” “n,” and “o.” For simplicity, FIG. 4 only illustrates four pixel positions, “A,” “B,” “C,” and “D,” of reference block 100, and only illustrates the sub-pixel positions associated with pixel position “A” 102. The entirety of reference block 100 may comprise a block of pixels with size 4×4, 4×8, 8×4, 8×8, 8×16, 16×8, 16×16, 16×32, 32×16, 32×32, or the like. In addition, the sub-pixel positions illustrated in the example of FIG. 4 comprise quarter-pixel positions. In other examples, every pixel position may be interpolated to have eighth-pixel positions.

Each pixel position may correspond to an upper left-hand corner of a video block such that the pixel position defines the video block. In the illustrated example, pixel position “A” 102 defines reference block 100. When interpolation is performed, all the pixels of a video block are interpolated the same way to calculate sub-pixel positions relative to the pixel positions, e.g., half-pixel positions or quarter-pixel positions. In this way, each sub-pixel position may correspond to an upper left-hand corner of an interpolated video block such that the sub-pixel position defines the interpolated video block. For example, sub-pixel position “g” 104 defines one interpolated version of reference block 100.

In the ITU H.264/AVC standard and the emerging HEVC standard, for example, a 6-tap Wiener filter with coefficients [1, −5, 20, 20, −5, 1] may be used to obtain luma signals at half-pixel positions. Then, a bilinear filter may be used to obtain luma signals at quarter-pixel locations. The bilinear filter may also be used in sub-pixel interpolation for the chroma components, which may have up to eighth-pixel precision in H.264/AVC and HEVC. The actual filters applied to generate interpolated data may be subject to a wide variety of implementations. As one example, motion compensation unit 44 in video encoder 20 from FIG. 2 may use adaptive interpolation filtering to define the interpolated values. In another example, several sets of fixed interpolation filters may be applied and the set that yields the best prediction data may be selected.

Regardless of the type of interpolations that are performed or the interpolation filters that are used, once the sub-pixel positions of reference block 100 are calculated, motion compensation unit 44 may generate prediction data based on at least one motion vector that points to one of the sub-pixel positions of reference block 100. In the case of weighted motion compensated prediction, video parameter values may then be applied to the prediction data to compensate for luminance and/or chrominance changes between the reference block and the video block to be coded. For example, the video parameter values may include a scale parameter value and/or an offset parameter value.

According to the techniques of this disclosure, video encoder 20 may only signal video parameter values for weighted motion compensated prediction when the motion vector points to a sub-pixel position of reference block 100 that is included in predefined sub-pixel list 68. In one example, predefined sub-pixel list 68 may include only sub-pixel position “g” 104. In this case, video encoder 20 may only signal video parameter values for the video block when the motion vector points to sub-pixel position “g” 104 of reference block 100. In another example, predefined sub-pixel list 68 may include sub-pixel positions “a” 106, “h” 107, and “k” 108. In this case, video encoder 20 may only signal video parameter values for the video block when the motion vector points to any one of sub-pixel positions “a” 106, “h” 107, or “k” 108.

When the motion vector does point to one of the predefined sub-pixels in list 68, motion compensation unit 44 may generate initial prediction data based on the motion vector and then apply video parameter values to adjust the initial prediction data to compensate for luminance and/or chrominance changes. Video encoder 20 may then encode the video block to be coded with respect to the prediction data generated based on both the motion vector and the video parameter values. In addition, video encoder 20 encodes syntax elements indicating the motion vector and the video parameter values associated with the motion vector. On the other hand, when the motion vector does not point to one of the predefined sub-pixels in list 68, video encoder 20 encodes the video block with respect to a prediction block generated based only on the motion vector. Video encoder 20 may then encode syntax elements indicating only the motion vector.

Video encoder 20 also signals the predefined sub-pixel list 68 to video decoder 30 at one of the CU level, the video slice level, the video frame level, or the video sequence level. In this way, video decoder 30 knows when to expect syntax elements indicating video parameter values associated with the motion vector. Video decoder 30 may then perform a reciprocal decoding of the video blocks with or without video parameter values.

In this way, video encoder 20 no longer signals video parameter values to video decoder 30 with every motion vector for every video block of a frame. By limiting the signaling of video parameter values for weighted motion compensated prediction to only those motion vectors that point to predefined sub-pixels, the techniques reduce signaling overhead and improve coding efficiency.

Adding scale parameter values and/or offset parameter values to the pixels of prediction data can help to capture effects of illumination changes between reference block 100 and the video block to be coded. Scale parameter values and offset parameter values may be used during a transition period of a chrominance effect or a luminance effect, such as a cross-fade, fade-in, fade-out, flash, or the like, that occurs over several frames. For example, a scale or weight parameter value may compensate for a luminance and/or chrominance change by increasing or decreasing the luminance and/or chrominance value at each pixel of a predictive block by a percentage indicated by the scale parameter value. An offset or DC parameter value may compensate for a luminance and/or chrominance change by increasing or decreasing the luminance and/or chrominance values at all the pixels of a predictive block by a common amount indicated by the offset parameter value.

In the H.264/AVC standard and the emerging HEVC standard, weighted motion compensated prediction allows scale parameter values and/or offset parameter values to be added to the pixel values of predictive blocks for use in coding video blocks. In the H.264/AVC standard, weighted motion compensated prediction is typically performed at the video frame level such that each video frame may have only one scale and/or offset parameter value. In the HEVC standard, weighted motion compensated prediction is typically performed at the video coding unit level such that each CU of a video frame may have only one scale and/or offset parameter value. In the above cases, the same luminance and/or chrominance increase or decrease is applied to an entire frame or an entire CU. The video parameter values signaled to video decoder 30 with each motion vector, therefore, may be the same for a given frame or CU.

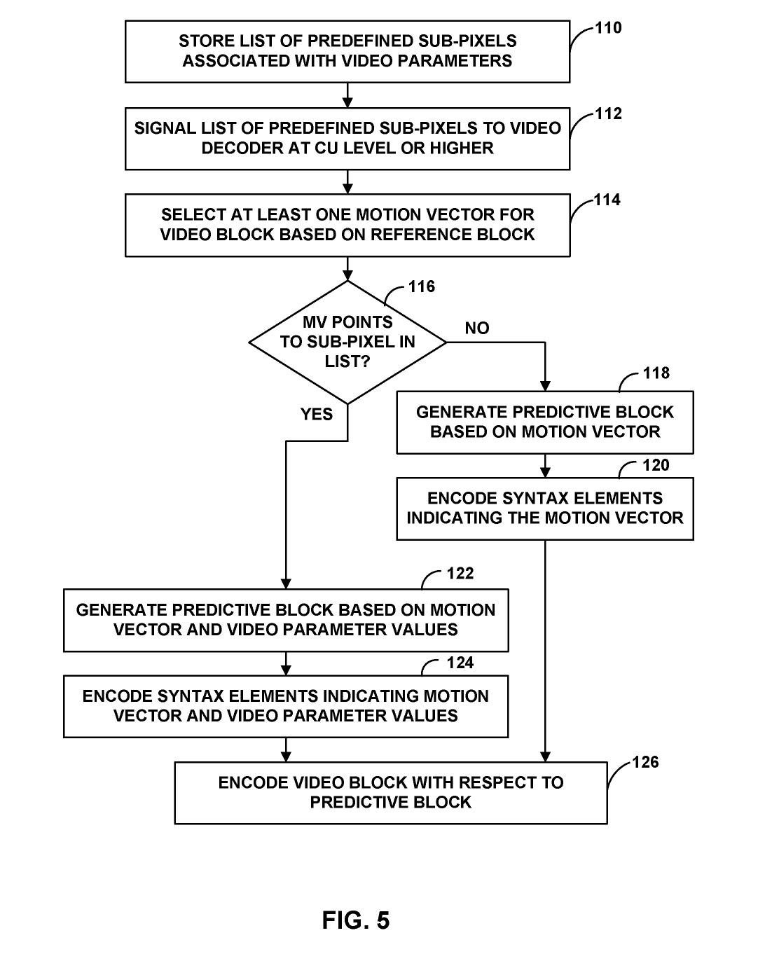

FIG. 5 is a flowchart illustrating an example operation of encoding video blocks using weighted motion compensated prediction with sub-pixel accuracy. The illustrated operation is described with reference to video encoder 20 of FIG. 2 although other devices may implement similar techniques.

Video encoder 20 stores predefined sub-pixel list 68 associated with one or more video parameters (110). Predefined sub-pixel list 68 may include a single list for the one or more video parameters, or multiple lists, one for each of the video parameters. For example predefined sub-pixel list 68 may comprise a first list associated with a scale parameter and a second list associated with an offset parameter. In some cases, predefined sub-pixel list 68 may be generated prior to encoding based on current or historical data regarding luminance and/or chrominance changes in a CU, a video slice, a video frame, or a video sequence. Video encoder 20 then signals predefined sub-pixel list 68 to video decoder 30 at one of the CU level, the slice level, the frame level, or the sequence level (112). In this way, video decoder 30 may know when to expect video parameter values and enable proper parsing of syntax elements to decode the expected video parameter values.

Video encoder 20 receives a video block of a video frame or slice to be encoded. Motion estimation unit 42 selects at least one motion vector for the video block to be encoded based on a reference block of a reference frame stored in reference frame memory 64 (114). In some examples, the reference block may have sub-pixel resolution. In this case, motion estimation unit 42 may compare the video block to be encoded with several different sub-pixel positions of the reference block, and select a motion vector that points to the sub-pixel potion of the reference block that provides prediction data closest to the video block to be encoded.

Motion compensation unit 44 receives the motion vector from motion estimation unit 42 and determines whether the motion vector points to a sub-pixel position of the reference block that is included in the predefined sub-pixel list 68 (116). If the motion vector does not point to one of the predefined sub-pixels in list 68 (NO branch of 116), motion compensation unit 44 generates a predictive block based only on the motion vector (118). Video encoder 20 encodes syntax elements indicating the motion vector (120). Video encoder 20 then encodes the video block with respect to the predictive block generated based only on the motion vector (126).

If the motion vector does point to one of the predefined sub-pixels in list 68 (YES branch of 116), motion compensation unit 44 generates the predictive block based on the motion vector and the video parameter values associated with the motion vector (122). More specifically, motion compensation unit 44 generates an initial predictive block from the reference block based on the motion vector, and then adjusts the initial predictive block based on the video parameter values associated with the motion vector. For example, motion compensation unit 44 may apply at least one of a scale parameter value and an offset parameter value to the initial predictive block to compensate for a luminance and/or chrominance change between the reference block and the video block to be encoded.

Video encoder 20 encodes syntax elements indicating the motion vector and video parameter values associated with the motion vector (124). A video frame or video coding unit (CU) may have a single value for each of the video parameters. For example, the same scale parameter value and/or offset parameter value may be associated with each motion vector for video blocks in the frame or prediction units (PUs) in the CU. Video encoder 20 then encodes the video block using weighted motion compensated prediction with respect to the predictive block generated based on both the motion vector and the video parameter values (126).

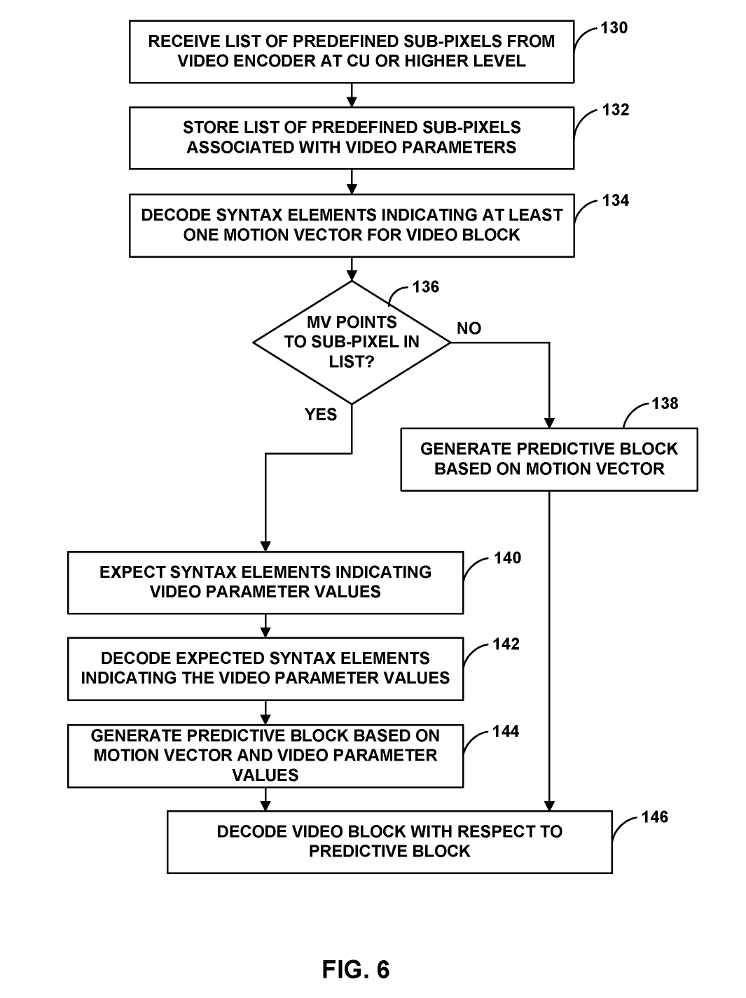

FIG. 6 is a flowchart illustrating an example operation of decoding video blocks using weighted motion compensated prediction with sub-pixel accuracy. The illustrated operation is described with reference to video decoder 30 of FIG. 3 although other devices may implement similar techniques.

Video decoder 30 receives a list of predefined sub-pixels signaled from video encoder 20 at one of the CU level, the slice level, the frame level, or the sequence level (130). Video decoder 30 stores the signaled list as predefined sub-pixel list 96 associated with one or more video parameters (132). Predefined sub-pixel list 96 may include a single list for the one or more video parameters, or multiple lists, one for each of the video parameters. For example predefined sub-pixel list 96 may comprise a first list associated with a scale parameter and a second list associated with an offset parameter.

Video decoder 30 receives a bitstream of encoded video data for a video frame or slice from video encoder 20. The bitstream includes syntax elements indicating motion compensated prediction information for a given video block to be decoded. Entropy decoding unit 80 decodes syntax elements indicating at least one motion vector for the video block (134). In some examples, the decoded motion vector may point to a reference block of a reference frame stored in reference frame memory 92 that has sub-pixel resolution. Motion compensation unit 82 determines whether the motion vector points to a sub-pixel position of the reference block that is included in the predefined sub-pixel list 96 (136). If the motion vector does not point to one of the predefined sub-pixels in list 96 (NO branch of 136), motion compensation unit 82 generates a predictive block based only on the motion vector (138). Video decoder 30 then decodes the video block with respect to the predictive block generated based only on the motion vector (146).

If the motion vector does point to one of the predefined sub-pixels in list 96 (YES branch of 136), motion compensation unit 82 expects to receive syntax elements indicating video parameter values associated with the motion vector (140). Motion compensation unit 82 may then properly parse the prediction syntax and decode the expected syntax elements indicating video parameter values (142). In some cases, a video frame or video coding unit (CU) may have a single value for each of the video parameters. For example, the same scale parameter value and/or offset parameter value may be associated with each motion vector for video blocks in the frame or prediction units (PUs) in the CU.

Motion compensation unit 82 then generates the predictive block based on the motion vector and the video parameter values associated with the motion vector (144). More specifically, motion compensation unit 82 generates an initial predictive block from the reference block based on the decoded motion vector, and then adjusts the initial predictive block based on the video parameter values associated with the motion vector. For example, motion compensation unit 82 may apply at least one of a scale parameter value and an offset parameter value to the initial predictive block to compensate for a luminance and/or chrominance change between the reference block and the video block to be decoded. Video decoder 30 then decodes the video block using weighted motion compensated prediction with respect to the predictive block generated based on both the motion vector and the video parameter values (146).

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

1. A method of coding video data comprising:
storing a list of predefined sub-pixels associated with one or more video parameters;
coding syntax elements indicating at least one motion vector for a video block with respect to a reference block having sub-pixel resolution; and
when the motion vector points to a sub-pixel position of the reference block that is included in the list of predefined sub-pixels, coding syntax elements indicating video parameter values associated with the motion vector, and coding the video block with respect to prediction data generated based on the motion vector and the video parameter values.

2. The method of claim 1, further comprising, when the motion vector points to a sub-pixel position of the reference block that is not included in the list of predefined sub-pixels, coding the video block with respect to prediction data generated based on only the motion vector.

3. The method of claim 1, further comprising signaling the list of predefined sub-pixels associated with the one or more video parameters at one of a coding unit level, a video slice level, a video frame level, or a video sequence level.

4. The method of claim 1, further comprising, when the motion vector points to a sub-pixel position of the reference block that is included in the list of predefined sub-pixels, generating initial prediction data based on the motion vector, and adjusting the initial prediction data based on the video parameter values to generate the prediction data used to code the video block.

5. The method of claim 1,
wherein coding syntax elements indicating at least one motion vector comprises decoding the syntax elements indicating the motion vector; and
wherein coding syntax elements indicating video parameter values comprises, when the decoded motion vector points to a sub-pixel position of the reference block that is included in the list of predefined sub-pixels, expecting to receive the syntax elements indicating the video parameter values associated with the motion vector, and decoding the expected syntax elements.

6. The method of claim 1,
wherein coding syntax elements indicating at least one motion vector comprises encoding the syntax elements indicating the motion vector; and
wherein coding syntax elements indicating video parameter values comprises, when the motion vector points to a sub-pixel position of the reference block that is included in the list of predefined sub-pixels, encoding the syntax elements indicating the video parameter values associated with the motion vector.

7. The method of claim 1, wherein the list of predefined sub-pixels includes one or more sub-pixels for which video parameter values will be associated with a motion vector to compensate for at least one of a luminance change and a chrominance change between the reference block and the video block.

8. The method of claim 1, wherein storing a list of predefined sub-pixels associated one or more video parameters comprises storing a list of predefined sub-pixels associated with at least one of a scale parameter and an offset parameter.

9. The method of claim 1, wherein storing a list of predefined sub-pixels associated with one or more video parameters comprises storing at least one of a first list of predefined sub-pixels associated with a scale parameter and a second list of predefined sub-pixels associated with an offset parameter, wherein the first list and the second list include different predefined sub-pixels.

10. The method of claim 9, wherein coding syntax elements indicating video parameter values comprises:
when the motion vector points to a first sub-pixel position of the reference block that is included in the first list of predefined sub-pixels, coding one or more syntax elements indicating a scale parameter value associated with the motion vector; and
when the motion vector points to a second sub-pixel position of the reference block that is included in the second list of predefined sub-pixels, coding one or more syntax elements indicating an offset parameter value associated with the motion vector.

11. The method of claim 1, wherein each coding unit of the video data comprises a single value for each of the one or more video parameters.

12. A video coding device comprising:
a memory that stores a list of predefined sub-pixels associated with one or more video parameters; and
a processor that codes syntax elements indicating at least one motion vector for a video block with respect to a reference block having sub-pixel resolution, and, when the motion vector points to a sub-pixel position of the reference block that is included in the list of predefined sub-pixels, codes syntax elements indicating video parameter values associated with the motion vector and codes the video block with respect to prediction data generated based on the motion vector and the video parameter values.

13. The video coding device of claim 12, wherein, when the motion vector points to a sub-pixel position of the reference block that is not included in the list of predefined sub-pixels, the processor codes the video block with respect to prediction data generated based on only the motion vector.

14. The video coding device of claim 12, wherein the processor signals the list of predefined sub-pixels associated with the one or more video parameters at one of a coding unit level, a video slice level, a video frame level, or a video sequence level.

15. The video coding device of claim 12, wherein, when the motion vector points to a sub-pixel position of the reference block that is included in the list of predefined sub-pixels, the processor generates initial prediction data based on the motion vector, and adjusts the initial prediction data based on the video parameter values to generate the prediction data used to code the video block.

16. The video coding device of claim 12, wherein the video coding device comprises a video decoding device, and wherein the processor decodes the syntax elements indicating the motion vector, and, when the decoded motion vector points to a sub-pixel position of the reference block that is included in the list of predefined sub-pixels, the processor expects to receive the syntax elements indicating the video parameter values associated with the motion vector and decodes the expected syntax elements.

17. The video coding device of claim 12, wherein the video coding device comprises a video encoding device, and wherein the processor encodes the syntax elements indicating the motion vector, and, when the motion vector points to a sub-pixel position of the reference block that is included in the list of predefined sub-pixels, the processor encodes the syntax elements indicating the video parameter values associated with the motion vector.

18. The video coding device of claim 12, wherein the list of predefined sub-pixels includes one or more sub-pixels for which video parameter values will be associated with a motion vector to compensate for at least one of a luminance change and a chrominance change between the reference block and the video block.

19. The video coding device of claim 12, wherein the memory stores a list of predefined sub-pixels associated with at least one of a scale parameter and an offset parameter.

20. The video coding device of claim 12, wherein the memory stores at least one of a first list of predefined sub-pixels associated with a scale parameter and a second list of predefined sub-pixels associated with an offset parameter, wherein the first list and the second list include different predefined sub-pixels.

21. The video coding device of claim 20, wherein:
when the motion vector points to a first sub-pixel position of the reference block that is included in the first list of predefined sub-pixels, the processor codes one of more syntax elements indicating a scale parameter value associated with the motion vector; and
when the motion vector points to a second sub-pixel position of the reference block that is included in the second list of predefined sub-pixels, the processor codes one or more syntax elements indicating an offset parameter value associated with the motion vector.

22. The video coding device of claim 12, wherein each coding unit of the video data comprises a single value for each of the one or more video parameters.

23. A video coding device comprising:
means for storing a list of predefined sub-pixels associated with one or more video parameters;
means for coding syntax elements indicating at least one motion vector for a video block with respect to a reference block having sub-pixel resolution; and
when the motion vector points to a sub-pixel position of the reference block that is included in the list of predefined sub-pixels, means for coding syntax elements indicating video parameter values associated with the motion vector, and means for coding the video block with respect to prediction data generated based on the motion vector and the video parameter values.

24. The video coding device of claim 23, further comprising, when the motion vector points to a sub-pixel position of the reference block that is not included in the list of predefined sub-pixels, means for coding the video block with respect to prediction data generated based on only the motion vector.

25. The video coding device of claim 23, further comprising means for signaling the list of predefined sub-pixels associated with the one or more video parameters at one of a coding unit level, a video slice level, a video frame level, or a video sequence level.

26. The video coding device of claim 23, further comprising, when the motion vector points to a sub-pixel position of the reference block that is included in the list of predefined sub-pixels, means for generating initial prediction data based on the motion vector, and means for adjusting the initial prediction data based on the video parameter values to generate the prediction data used to code the video block.

27. The video coding device of claim 23, wherein the video coding device comprises a video decoding device, further comprising:
means for decoding the syntax elements indicating the motion vector; and when the decoded motion vector points to a sub-pixel position of the reference block that is included in the list of predefined sub-pixels, means for expecting to receive the syntax elements indicating the video parameter values associated with the motion vector, and means for decoding the expected syntax elements.

28. The video coding device of claim 23, wherein the list of predefined sub-pixels includes one or more sub-pixels for which video parameter values will be associated with a motion vector to compensate for at least one of a luminance change and a chrominance change between the reference block and the video block.

29. The video coding device of claim 23, further comprising means for storing a list of predefined sub-pixels associated with at least one of a scale parameter and an offset parameter.

30. The video coding device of claim 23, further comprising means for storing at least one of a first list of predefined sub-pixels associated with a scale parameter and a second list of predefined sub-pixels associated with an offset parameter, wherein the first list and the second list include different predefined sub-pixels.

31. A computer-readable storage medium comprising instructions for coding video data that, upon execution in a processor, cause the processor to:
store a list of predefined sub-pixels associated with one or more video parameters;
code syntax elements indicating at least one motion vector for a video block with respect to a reference block having sub-pixel resolution; and
when the motion vector points to a sub-pixel position of the reference block that is included in the list of predefined sub-pixels, code syntax elements indicating video parameter values associated with the motion vector, and code the video block with respect to prediction data generated based on the motion vector and the video parameter values.

32. The computer-readable storage medium of claim 31, further comprising, when the motion vector points to a sub-pixel position of the reference block that is not included in the list of predefined sub-pixels, instructions that cause the processor to code the video block with respect to prediction data based on only the motion vector.

33. The computer-readable storage medium of claim 31, further comprising instructions that cause the processor to signal the list of predefined sub-pixels associated with the one or more video parameters at one of a coding unit level, a video slice level, a video frame level, or a video sequence level.

34. The computer-readable medium of claim 31, further comprising, when the motion vector points to a sub-pixel position of the reference block that is included in the list of predefined sub-pixels, instructions that cause the processor to generate initial prediction data based on the motion vector, and adjust the initial prediction data based on the video parameter values to generate the prediction data used to code the video block.

35. The computer-readable storage medium of claim 31, wherein the instructions cause the processor to:
decode the syntax elements indicating the motion vector; and when the decoded motion vector points to a sub-pixel position of the reference block that is included in the list of predefined sub-pixels, expect to receive the syntax elements indicating the video parameter values associated with the motion vector, and decode the expected syntax elements.

36. The computer-readable storage medium of claim 31, wherein the list of predefined sub-pixels includes one or more sub-pixels for which video parameter values will be associated with a motion vector to compensate for at least one of a luminance change and a chrominance change between the reference block and the video block.

37. The computer-readable storage medium of claim 31, wherein the instructions cause the processor to store a list of predefined sub-pixels associated with at least one of a scale parameter and an offset parameter.

38. The computer-readable storage medium of claim 31, wherein the instructions cause the processor to store at least one of a first list of predefined sub-pixels associated with a scale parameter and a second list of predefined sub-pixels associated with an offset parameter, wherein the first list and the second list include different predefined sub-pixels.
